(19) United States
(12) Patent Application Publication
(10) Pub. No.: US 2003/0221509 A1
(43) Pub. Date: Dec. 4, 2003

(54) Handlebar stem

(76) Inventor: Chang-Hui Lin, Tsang-Hwa Hsieh (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/161,243

(22) Filed: May 31, 2002

(51) Int. Cl. B62K 21/12

(52) U.S. Cl. 74/551.1

(57) ABSTRACT

A handlebar stem is an elongated body with a main passage defined therethrough. A first end of the body is connected to a handlebar and a second end of the body has two lugs extending therefrom so as to be mounted onto the steerer tube of a bike. A plurality of concavities are defined in an outer surface of each of the two lugs so as to form a fatigue detection area on each of the lugs and cracks caused by stress during the operation of the bike are seen in the fatigue detection area.

### FIELD OF THE INVENTION

The present invention relates to a handlebar stem for mountain bike and a plurality of concavities defined in an outer surface of the handlebar stem so that the user may observe tiny cracks before the handlebar stem is severely damaged.

### BACKGROUND OF THE INVENTION

A conventional handlebar stem for mountain bikes or heavy-duty bikes is required to have better structural strength so that the modern handlebar stem for mountain bikes is made to have larger diameter and thicker wall. In order to reduce the total weight of the whole bicycle, the handlebar stem is usually made of Aluminum and has one end thereof fixed to the steerer tube extending from the head tube and the other end of the handlebar stem is connected with the cross bar of the handlebar. For mountain bikes, they are operated to jump up and down on the serrated road and the handlebar stem is applied by a large and sudden stress. It is dangerous if the handlebar stem is broken during operation of the mountain bike. The possible damage could happen at the position where the cross bar of the handlebar and the stem, and/or the position where the steerer tube and the handlebar stem. This damage can hardly be seen because it starts with tiny cracks and could be covered by the coating on the handlebar stem.

### SUMMARY OF THE INVENTION

In accordance with one aspect of the present invention, there is provided a handlebar stem which comprises a main passage defined therethrough and a first end piece is connected to a first end of the body and a second end piece is connected to the first end piece. A first passage is defined between the first end piece and the second end piece so as to receive a handlebar. Two lugs extend from a second end of the body and a second passage is defined between the two lugs so as to receive a steerer tube therethrough. A plurality of concavities are defined in an outer surface of each of the two lugs.

The primary object of the present invention is to provide a handlebar stem that has concavities in the outer surface and the cracks will be happened at the positions of the concavities because the positions are the weak portion of the handlebar stem.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handlebar stem of the present invention;

FIG. 2 is a perspective view to show the handlebar stem of the present invention;

FIG. 3 is a cross sectional view to show the handlebar stem of the present invention, and

FIG. 4 shows the steerer tube and the handlebar are respectively connected to two ends of the handlebar stem of the present invention.

### DETAILED DESCRIPTION OF THE PREFERRED EMBODIMENT

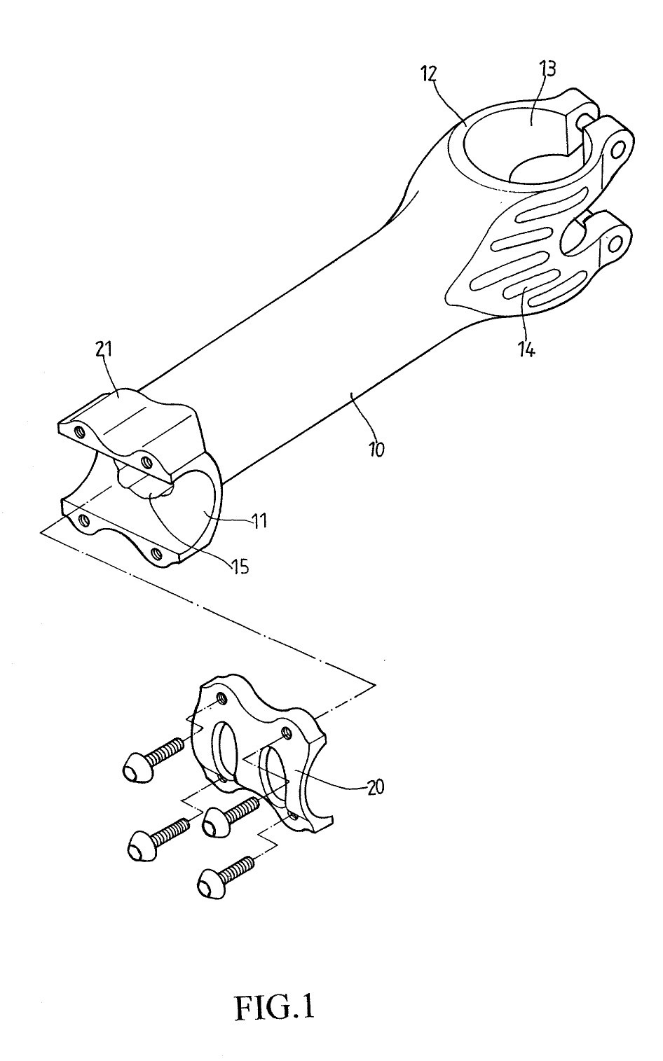

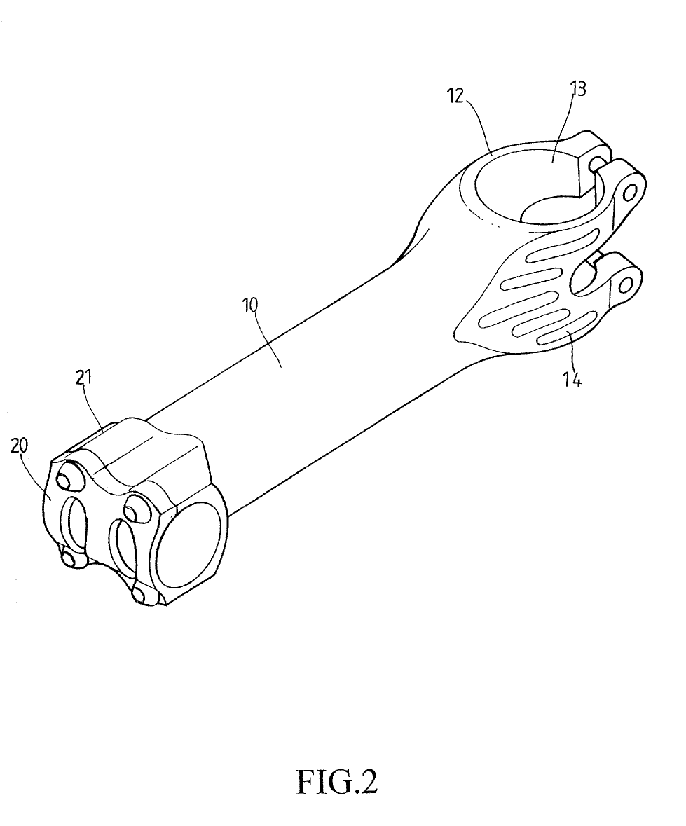

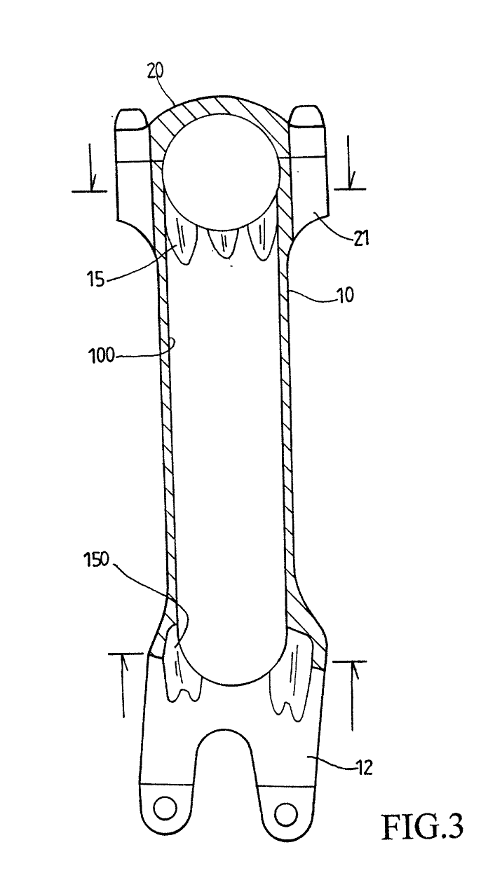

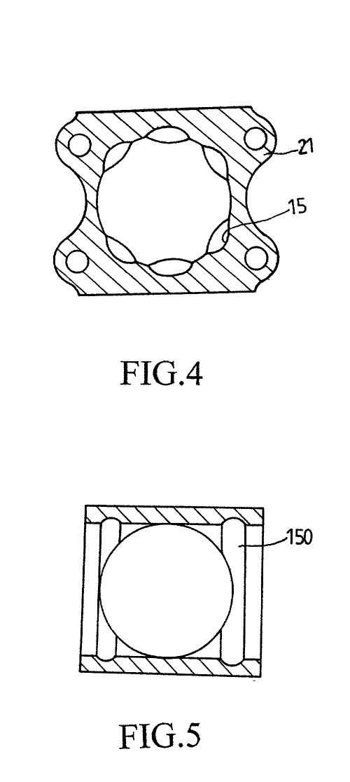

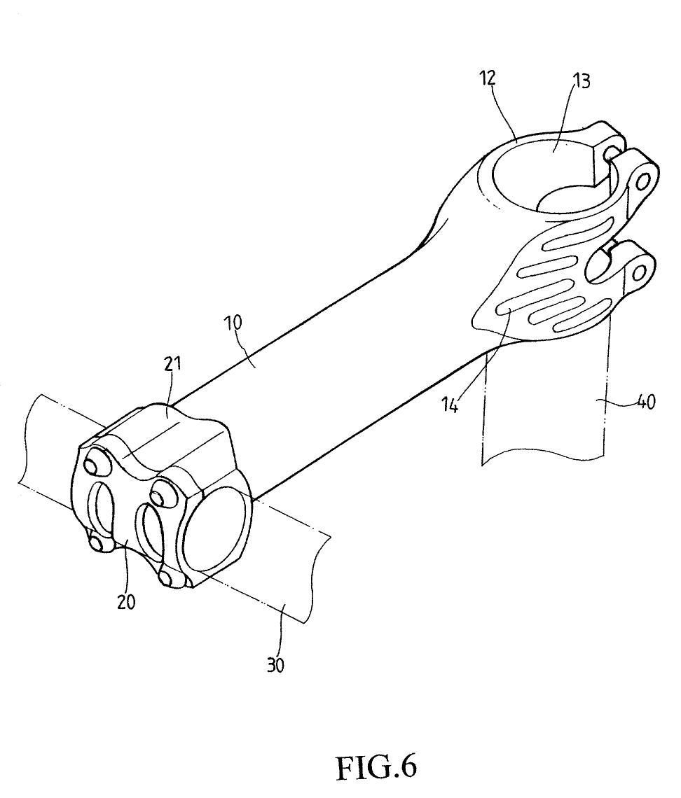

Referring to FIGS. 1 to 3, the handlebar stem 10 of the present invention is an elongated body 10 having a main passage 100 defined therethrough. A first end piece 21 is connected to a first end of the body 10 and a second end piece 20 is connected to the first end piece 21 by four bolts extending through four corners of the second end piece 20 and threadedly engaged with the first end piece 21. A first passage 11 is defined between the first end piece 21 and the second end piece 20 so as to receive a handlebar 30 as shown in FIG. 4.

Two lugs 12 extend from a second end of the body 10 and each lug 12 has a concave inner surface so as to define a second passage 13 between the two lugs 12. A steerer tube 40 extending through the head tube (not shown) is securely mounted by the two lugs 12 and extends through the second passage 13. A plurality of concavities 14 are defined in an outer surface of each of the two lugs 12 so as to form a fatigue detection area at each of the two lugs 12. The concavities 14 are located at radial and longitudinal positions corresponding to the main passage 100. The concavities 14 are located radially corresponding to the main passage and majority of the concavities 14 are located at the longitudinal positions. The concavities 14 extend inward the body 10 and form a fatigue detection area.

A plurality of first grooves 15 are defined in a conjunction portion between the inner periphery of the main passage 100 and an opening in the first end piece 21. The first grooves 15 are located in an inner periphery of the main passage 100 and extend longitudinally toward the second end of the body 10.

A plurality of second grooves 150 are defined in a conjunction portion between the inner periphery of the main passage 100 and an opening in the second end of the body 10. The second grooves 150 are located in an inner periphery of the second passage 13 and in a form of a circular groove.

The areas that the first grooves 15 and the second grooves 150 are located also form two fatigue detection areas where cracks could be happened at the fatigue detection areas and can be seen easily.

The fatigue detection areas of the handlebar stem 10 of the present invention provide an early-warning convenience and the cracks can be seen in the fatigue detection areas so that the riders may replace the handlebar stem 10 before it is severely damaged.

While we have shown and described the embodiment in accordance with the present invention, it should be clear to those skilled in the art that further embodiments may be made without departing from the scope of the present invention.

What is claimed is:

1. A handlebar stem comprising:
an elongated body having a main passage defined therethrough, the body having a first passage defined in a first end thereof so as to be adapted to be connected to a handlebar, the body having a second passage defined in a second end thereof so as to be adapted to be connected to a steerer tube;
a plurality of concavities defined in an outer surface of the body and located at radial and longitudinal positions corresponding to the main passage, the concavities extending inward the body and forming a fatigue detection area.

2. The handlebar stem as claimed in claim 1 wherein the concavities are located radially corresponding to the main passage and majority of the concavities are located at the longitudinal positions.

3. The handlebar stem as claimed in claim 1 further comprising a first end piece connected to a first end of the body and a second end piece connected to the first end piece, the first passage defined between the first end piece and the second end piece so as to be adapted to receive a handlebar, first grooves defined in a conjunction portion between the inner periphery of the main passage and an opening in the first end piece, the first grooves located in an inner periphery of the main passage and extending longitudinally toward the second end of the body.

4. The handlebar stem as claimed in claim 1 further comprising a first end piece connected to a first end of the body and a second end piece connected to the first end piece, the first passage defined between the first end piece and the second end piece so as to be adapted to receive a handlebar, second grooves defined in a conjunction portion between the inner periphery of the main passage and an opening in the second end of the body, the second grooves located in an inner periphery of the second passage and in a form of a circular groove.

5. A handlebar stem comprising:
an elongated body having a main passage defined therethrough, a first end piece connected to a first end of the body and a second end piece connected to the first end piece, a first passage defined between the first end piece and the second end piece so as to be adapted to receive a handlebar, and
two lugs extending from a second end of the body and a second passage defined between the two lugs so as to be adapted to receive a steerer tube, circular second grooves defined in an inner periphery of the second passage.

6. The handlebar stem as claimed in claim 5 further comprising a plurality of concavities defined in an outer surface of the body and located at radial and longitudinal positions corresponding to the second passage, the concavities extending inward the body and forming a fatigue detection area.

7. The handlebar stem as claimed in claim 5 further comprising first grooves defined in a conjunction portion between the inner periphery of the main passage and an opening in the first end piece, the first grooves located in an inner periphery of the main passage and extending longitudinally toward the second end of the body.

8. A handlebar stem comprising:
an elongated body having a main passage defined therethrough, a first end piece connected to a first end of the body and a second end piece connected to the first end piece, a first passage defined between the first end piece and the second end piece so as to be adapted to receive a handlebar, and
two lugs extending from a second end of the body and a second passage defined between the two lugs so as to be adapted to receive a steerer tube, first grooves defined in a conjunction portion between the inner periphery of the main passage and an opening in the first end piece, the first grooves located in an inner periphery of the main passage and extending longitudinally toward the second end of the body.

9. The handlebar stem as claimed in claim 8 further comprising circular second grooves defined in a conjunction portion between the inner periphery of the main passage and an opening in the second end of the body, the second grooves located in an inner periphery of the second passage and in a form of a circular groove.

10. The handlebar stem as claimed in claim 9 further comprising a plurality of concavities defined in an outer surface of the body and located at radial and longitudinal positions corresponding to the second passage, the concavities extending inward the body and forming a fatigue detection area.
